(19) United States
(12) Patent Application Publication
(10) Pub. No.: US 2004/0107360 A1
(43) Pub. Date: Jun. 3, 2004

(54) System and Methodology for Policy Enforcement

(75) Inventors: Conrad K. Herrmann, Oakland, CA (US); Sinduja Murari, Fremont, CA (US)

Correspondence Address: JOHN A. SMART, 708 BLOSSOM HILL RD., #201, LOS GATOS, CA, 95032, US

(73) Assignee: ZONE LABS, INC., San Francisco, CA (US)

(21) Appl. No.: 10/249,073

(22) Filed: Mar. 13, 2003

Related U.S. Application Data
(60) Provisional application No. 60/430,458, filed on Dec. 2, 2002.

(51) Int. Cl. H04L 9/00

(52) U.S. Cl. 713/201

(57) ABSTRACT

A system and methodology for policy enforcement during authentication of a client device for access to a network is described. A first authentication module establishes a session with a client device requesting network access for collecting information from the client device and determining whether to authenticate the client device for access to the network based, at least in part, upon the collected information. A second authentication module participates in the session with the client device for supplemental authentication of the client device for access to the network. The supplemental authentication of the client device is based, at least in part, upon the collected information and a policy required as a condition for network access.

### CROSS REFERENCE TO RELATED APPLICATIONS

### REFERENCED-APPLICATIONS

The present application is related to and claims the benefit of priority of the following commonly-owned provisional application(s): application Ser. No. 60/430,458 (Docket No. VIV/0010.00), filed Dec. 2, 2002, entitled “System and Methodology for Policy Enforcement”, of which the present application is a non-provisional application thereof. The present application is related to the following commonly-owned application(s): application Ser. No. 10/159,820 (Docket No. VIV/0005.01), filed May 31, 2002, entitled “System and Methodology for Security Policy Arbitration”; application Ser. No. 09/944,057 (Docket No. VIV/0003.01), filed Aug. 30, 2001, entitled “System Providing Internet Access Management with Router-based Policy Enforcement”. The disclosures of each of the foregoing applications are hereby incorporated by reference in their entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF INVENTION

The present invention relates generally to information processing and, more particularly, to systems and methods for policy enforcement on computer systems connected to one or more networks, such as Local Area Networks (LANs) and Wide Area Networks (WANs), including the Internet.

The first computers were largely stand-alone units with no direct connection to other computers or computer networks. Data exchanges between computers were mainly accomplished by exchanging magnetic or optical media such as floppy disks. Over time, more and more computers were connected to each other using Local Area Networks or “LANs”. In both cases, maintaining security and controlling what information a computer user could access was relatively simple because the overall computing environment was limited and clearly defined.

In traditional computing networks, a desktop computer largely remained in a fixed location and was physically connected to a single local network (e.g., via Ethernet). More recently, however, an increasingly large number of business and individual users are using portable computing devices, such as laptop computers, that are moved frequently and that connect into more than one network. For example, many users now have laptop computers that can be connected to networks at home, at work, and in numerous other locations. Many users also have home computers that are remotely connected to various organizations from time to time through the Internet. The number of computing devices, and the number of networks that these devices connect to, has increased dramatically in recent years.

In addition, various different types of connections may be utilized to connect to these different networks. A wireline connection (e.g., dial-up, ISDN, DSL, cable modem, T1, or the like) may be used for remote access to a network. Various types of wireless connectivity, including IEEE (Institute of Electrical and Electronics Engineers) 802.11 and Bluetooth, are also increasingly popular. Wireless networks often have a large number of different users that are occasionally connected from time to time. Moreover, connection to these networks is often very easy, as connection does not require a physical link. Wireless and other types of networks are frequently provided in cafes, airports, convention centers, and other public locations to enable mobile computer users to connect to the Internet. Increasingly, users are also using the Internet to remotely connect to a number of different systems and networks. For example, a user may connect his or her home computer to a corporate network through a virtual private network (VPN) which creates a secure Internet session between the home computer and the corporation's servers. The user may also connect this same home computer to his or her bank for on-line banking. Thus, it is becoming more common for users to connect to a number of different networks from time to time through a number of different means.

The organization (e.g., an Internet service provider) providing access to a network usually provides access through a network access server (NAS). There are a wide variety of different types of network access servers providing access to different systems and networks, including a dial-up endpoint providing access to client devices via dial-up connection, a VPN concentrator serving a virtual private network, a wireless base station providing network access via wireless connection, a router, and a number of other devices that provide network access.

The organization providing access to the network through a network access server (NAS) usually requires the client to authenticate that it is entitled to access the network before it is granted network access. Accordingly, a network access server environment generally includes one or more client devices/computers trying to gain access to a network, a network access server (NAS) which provides access to the network, and a primary authentication server to provide centralized authentication services to the NAS for authenticating client devices before they are granted access to the network. In typical installations, the client devices are personal computers or laptop (portable) computers which are connecting through the NAS to obtain access to a network (e.g., the Internet) via dial-up, cable or DSL (Direct Subscriber Line) connection, wireless connection, or the like. The authentication server is typically a RADIUS (Remote Authentication Dial-In User Service) server.

In this type of network access server environment, the Extensible Authentication Protocol (EAP) is typically used for network authentication. For further information regarding EAP, see e.g., “RFC 2284: PPP Extensible Authentication Protocol,” by the Internet Engineering Task Force (IETF), the disclosure of which is hereby incorporated by reference. A copy of RFC 2284 is currently available via the Internet at www.ietf.org/rfc/rfc2284.txt. EAP is a general protocol for authentication, which supports multiple authentication mechanisms. These authentication methods include not only user name and password, but also a number of other types of authentication, such as certificate-based authentication and token card-based authentication. Each EAP authentication mechanism is designated an EAP type such as EAP-MD5, EAP-OTP, and EAP-GTC, which also serves as identification for the authentication mechanism used for the session. The client devices and the authentication server (e.g., RADIUS server) exchange EAP messages by embedding them as attributes of a RADIUS packet. For further information regarding RADIUS, see, e.g., “RFC 2865: Remote Authentication Dial In User Service (RADIUS),” by the IETF, the disclosure of which is hereby incorporated by reference. A copy of RFC 2865 is currently available via the Internet at www.ietf.org/rfc/rfc2865.txt. See also e.g., “RFC 2868: RADIUS Attributes for Tunnel Protocol Support,” by the IETF.

In a typical scenario, a client device connects to a NAS (e.g., by wireline connection such as dial-up, ISDN, DSL, cable modem, T1, or the like or by wireless connection) in an attempt to logon to a network. During this process, a RADIUS server is typically invoked to perform authentication services using the applicable authentication mechanism. The authentication process may, for example, require the client to supply a user name and a password. If the authentication process succeeds, the client device is then permitted to access the network through the NAS.

Although the NAS and RADIUS servers are widely used to control access to computer systems and networks, several problems remain. One problem that is not addressed by current NAS and RADIUS technology is ensuring that all devices that connect to a network comply with and enforce applicable security policies. Organizations permitting access to their networks are increasingly requiring compliance with organizational security policies in order to protect their networks and systems. For example, if a remote user that is connected to a bank for on-line banking does not apply and enforce the bank's required security policies, a hacker could gain unauthorized access to the bank's systems through the remote user's unsecured system. Although a secure connection may be established between the bank and the user through use of the NAS infrastructure described above, and the RADIUS server may authenticate that the user is authorized to access the bank's systems, if the user's system is vulnerable to any security breaches, the security of the overall environment may be jeopardized.

A related problem is that if a client device connected to a network (e.g., through a NAS gateway) is infected with a virus or worm, it may infect other machines on the same network. An infected computer that is connected to a particular network (e.g., a corporate LAN) may be infected with a virus that intentionally tries to spread itself to other machines in the network. One machine that is not running the correct anti-virus engine or is not equipped with current virus signature definition files may jeopardize the security of the entire network. Ensuring that devices connected to the network are running current anti-virus programs is particularly important, as virus suppression methods are very time sensitive. New viruses are frequently released that cannot be identified using older anti-virus engines and definition files. It becomes critical, therefore, to promptly update anti-virus applications on all machines in a network in a timely fashion before the network is infiltrated by a newly released virus.

One existing approach which addresses some of these problems is to provide a separate filtering module which is included in the environment to provide another layer of security enforcement. With this approach, a client device may establish a session through the NAS and then communicate with a separate security module that enforces security standards by, in effect, serving as a firewall which can act to restrict (i.e., filter) network traffic. Although this filtering solution does provide the ability to enforce security requirements, there are disadvantages to this approach. For one thing, it requires the installation of an additional filtering system in the network access server environment. This approach also makes the performance of the NAS dependent to a large degree on the performance of the filtering system, which adversely impacts overall system performance.

A solution is needed which ensures that client devices connecting to a network are using appropriate security mechanisms and have required security policies in place to maintain the overall security of the network. The solution should work in conjunction with existing NAS implementations, without adversely affecting performance of such systems. Rather than requiring another layer of complex protocol filtering which may adversely impact system performance, the solution should take advantage of existing NAS and RADIUS server mechanisms. Ideally, the solution will work seamlessly in conjunction with existing NAS implementations to ensure that client devices connecting to a network are checked at the time they are requesting access to the network through the NAS to verify that the client devices have appropriate security mechanisms installed and operational. The solution should also work in conjunction with the various different EAP authentication mechanisms (e.g., EAP-MD5, EAP-OTP, EAP-GTC, and the like) that may be used to authenticate client devices connecting to the network. The present invention provides a solution for these and other needs.

### SUMMARY OF INVENTION

A system and methodology for policy enforcement during authentication of a client device for access to a network is described. A first authentication module establishes a session with a client device requesting network access for collecting information from the client device and determining whether to authenticate the client device for access to the network based, at least in part, upon the collected information. A second authentication module participates in the session with the client device for supplemental authentication of the client device for access to the network. The supplemental authentication of the client device is based, at least in part, upon the collected information and a policy required as a condition for network access.

### BRIEF DESCRIPTION OF DRAWINGS

FIG. 1 is a block diagram of a computer system in which software-implemented processes of the present invention may be embodied.

FIG. 2 is a block diagram of a software system for controlling the operation of the computer system.

FIG. 3 is a block diagram of an exemplary network access server environment illustrating the basic architecture of a network access system including a RADIUS server.

FIG. 4 is a block diagram of an environment in which the present invention is preferably embodied.

FIG. 5 is a block diagram illustrating the operations of the proxy server and the integrity gateway (IGW) server in greater detail.

FIG. 6A illustrates an (unwrapped) EAP packet containing policy data.

FIG. 6B illustrates a wrapped EAP packet comprising an EAP packet which contains another EAP packet as its data.

FIGS. 7A-C comprise a single flowchart illustrating the high-level methods of operation of the system of the present invention in policy enforcement.

### DETAILED DESCRIPTION

Glossary

The following definitions are offered for purposes of illustration, not limitation, in order to assist with understanding the discussion that follows.

Data link-layer: The data link-layer is the layer at which blocks of data are reliably transmitted over a transmission link as defined in the OSI (Open Systems Interconnection) Reference Model. The OSI Reference Model is a logical structure for communication systems standardized by the International Standards Organization (ISO) as ISO/IED standard 7498-1:1994: “Information technology—Open Systems Interconnection—Basic Reference Model: The Basic Model,” available from the ISO, the disclosure of which is hereby incorporated by reference. At the data link-layer, data packets are encoded and decoded into bits. The data link-layer is divided into two sublayers: the media access control (MAC) layer and the logical link control (LLC) layer. The MAC sublayer controls how a computer on the network gains access to the data and permission to transmit it. The LLC sublayer controls frame synchronization, flow control, and error checking.

EAP: The Extensible Authentication Protocol (EAP) is a general protocol for authentication, which supports multiple authentication mechanisms. Each EAP authentication mechanism is designated an EAP type such as EAP-MD5, EAP-OTP, and EAP-GTC for example, which also serves as identification for the authentication mechanism used for the session. The clients and an authentication server (e.g., RADIUS server) typically exchange EAP messages by embedding them as attributes of a RADIUS packet. For further information regarding EAP, see e.g., “RFC 2284: PPP Extensible Authentication Protocol,” available from the Internet Engineering Task Force (IETF), the disclosure of which is hereby incorporated by reference. A copy of RFC 2284 is currently available via the Internet at www.ietf.org/rfc/rfc2284.txt. See also e.g., “RFC 2716: PPP EAP TLS Authentication Protocol,” available from the IETF, the disclosure of which is hereby incorporated by reference. A copy of RFC 2716 is currently available via the Internet at www.ietf.org/rfc/rfc2716.txt.

End point security: End point security is a way of managing and enforcing security on each computer instead of relying upon a remote firewall or a remote gateway to provide security for the local machine or environment. End point security involves a security agent that resides locally on each machine. This agent monitors and controls the interaction of the local machine with other machines and devices that are connected on a LAN or a larger wide area network (WAN), such as the Internet, in order to provide security to the machine.

Firewall: A firewall is a set of related programs, typically located at a network gateway server, that protects the resources of a private network from other networks by controlling access into and out of the private network. (The term also implies the security policy that is used with the programs.) A firewall, working closely with a router program, examines each network packet to determine whether to forward it toward its destination. A firewall may also include or work with a proxy server that makes network requests on behalf of users. A firewall is often installed in a specially designated computer separate from the rest of the network so that no incoming request directly accesses private network resources.

GSS-API: The Generic Security Services Application Program Interface (GSS-API) provides application programmers uniform access to security services using a variety of underlying cryptographic mechanisms. The GSS-API allows a caller application to authenticate a principal identity, to delegate rights to a peer, and to apply security services such as confidentiality and integrity on a per-message basis. Examples of security mechanisms defined for GSS-API include “The Simple Public-Key GSS-API Mechanism” [SPKM] and “The Kerberos Version 5 GSS-API Mechanism” [KERBV5]. For further information regarding GSS-API, see e.g., “RFC 2743: Generic Security Service Application Program Interface Version 2, Update 1,” available from the IETF, the disclosure of which is hereby incorporated by reference. A copy of RFC 2743 is currently available via the Internet at www.ietf.org/rfc/rfc2743.txt. See also e.g., “RFC 2853: Generic Security Service API Version 2: Java Bindings,” available from the IETF, the disclosure of which is hereby incorporated by reference. A copy of RFC 2743 is currently available via the Internet at www.ietf.org/rfc/rfc2743.txt.

MD5: MD5 is a message-digest algorithm which takes as input a message of arbitrary length and produces as output a 128-bit “fingerprint” or “message digest” of the input. The MD5 algorithm is used primarily in digital signature applications, where a large file must be “compressed” in a secure manner before being encrypted with a private (secret) key under a public-key cryptosystem. Further description of MD5 is available in “RFC 1321: The MD5 Message-Digest Algorithm,” (April 1992), the disclosure of which is hereby incorporated by reference.

Network: A network is a group of two or more systems linked together. There are many types of computer networks, including local area networks (LANs), virtual private networks (VPNs), metropolitan area networks (MANs), campus area networks (CANs), and wide area networks (WANs) including the Internet. As used herein, the term “network” refers broadly to any group of two or more computer systems or devices that are linked together from time to time (or permanently).

RADIUS: RADIUS is short for Remote Authentication Dial In User Service, an authentication and accounting system used by many Internet Service Providers (ISPs). When dialing in to an ISP a client must be authenticated before it is provided access to the network, typically by entering a username and a password. This information is passed to a RADIUS server, which checks that the information is correct, and then permits access to the network. For further information regarding RADIUS, see e.g., “RFC 2865: Remote Authentication Dial In User Service (RADIUS),” available from the IETF, the disclosure of which is hereby incorporated by reference. A copy of RFC 2865 is currently available via the Internet at www.ietf.org/rfc/rfc2865.txt. See also e.g., “RFC 2868: RADIUS Attributes for Tunnel Protocol Support,” available from the IETF.

Security policy: In general terms, a security policy is an organization's statement defining the rules and practices that regulate how it will provide security, handle intrusions, and recover from damage caused by security breaches. An explicit and well-defined security policy includes a set of rules that are used to determine whether a given subject will be permitted to gain access to a specific object. A security policy may be enforced by hardware and software systems that effectively implement access rules for access to systems and information. Further information on security policies is available in “RFC 2196: Site Security Handbook, (September 1997),” the disclosure of which is hereby incorporated by reference. For additional information, see also e.g., “RFC 2704: The KeyNote Trust Management System Version 2,” available from the IETF, the disclosure of which is hereby incorporated by reference. A copy of RFC 2704 is currently available from the IETF via the Internet at www.ietf.org/rfc/rfc2704.txt. In this document, “security policy” or “policy” refers to a set of security policies and rules employed by an individual or by a corporation, government entity, or any other organization operating a network or other computing resources.

SSL: SSL is an abbreviation for Secure Sockets Layer, a protocol developed by Netscape for transmitting private documents over the Internet. SSL works by using a public key to encrypt data that is transferred over the SSL connection. Both Netscape Navigator and Microsoft Internet Explorer support SSL, and many Web sites use the protocol to obtain confidential user information, such as credit card numbers. SSL creates a secure connection between a client and a server, over which data can be sent securely. For further information, see e.g., “The SSL Protocol, version 3.0,” (Nov. 18, 1996), from the Internet Engineering Task Force (IETF), the disclosure of which is hereby incorporated by reference. See also, e.g., “RFC 2246: The TLS Protocol, version 1.0,” available from the IETF. A copy of RFC 2246 is currently available via the Internet at www.itef.org/rfc/rfc2246.txt.

XML: XML stands for Extensible Markup Language, a specification developed by the World Wide Web Consortium (W3C). XML is a pared-down version of the Standard Generalized Markup Language (SGML) which is designed especially for Web documents. It allows designers to create their own customized tags, enabling the definition, transmission, validation, and interpretation of data between applications and between organizations. For further description of XML, see e.g., “Extensible Markup Language (XML) 1.0,” (2nd Edition, Oct. 6, 2000) a recommended specification from the W3C, the disclosure of which is hereby incorporated by reference. A copy of this specification is currently available on the Internet at www.w3.org/TR/2000/REC-xml-20001006.

Introduction

The following description will focus on the presently-preferred embodiment of the present invention, which is implemented in desktop and/or server software (e.g., driver, application, or the like) operating in an Internet-connected environment running under an operating system, such as the Microsoft® Windows operating system. The present invention, however, is not limited to any one particular application or any particular environment. Instead, those skilled in the art will find that the system and methods of the present invention may be advantageously embodied on a variety of different platforms, including Macintosh, Linux, BeOS, Solaris, UNIX, NextStep, FreeBSD, and the like. Therefore, the description of the exemplary embodiments that follows is for purposes of illustration and not limitation.

Computer-Based Implementation

Basic System Hardware (e.g., for Desktop and Server Computers)

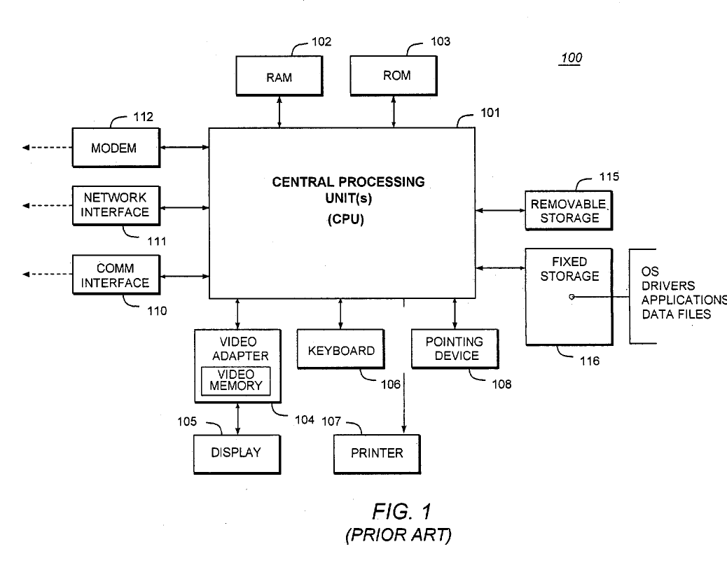

The present invention may be implemented on a conventional or general-purpose computer system, such as an IBM-compatible personal computer (PC) or server computer. FIG. 1 is a very general block diagram of an IBM-compatible system 100. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real-time system clock is included with the system 100, in a conventional manner.

CPU 101 comprises a processor of the Intel Pentium® family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

Basic System Software

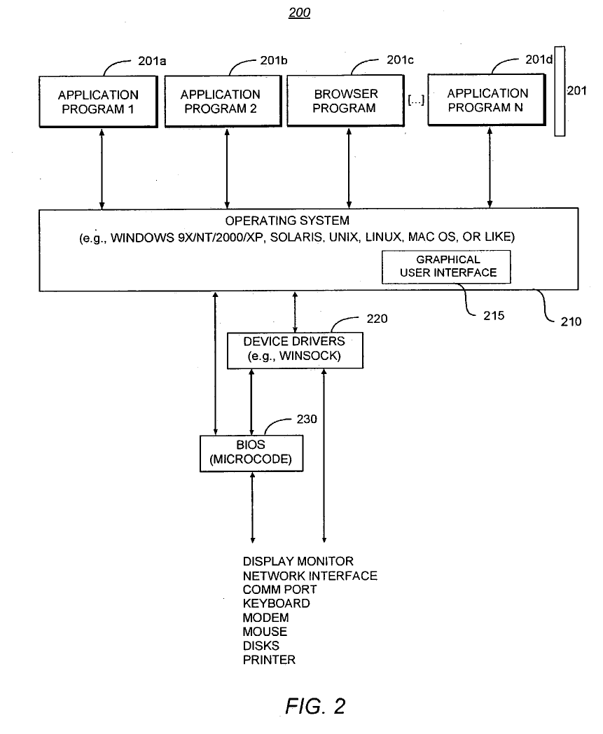

Illustrated in FIG. 2, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100. The applications or other software intended for use on the computer system 100 may also be stored as a set of downloadable computer-executable instructions, for example, for downloading and installation from an Internet location (e.g., Web server).

System 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described computer hardware and software are presented for purposes of illustrating the basic underlying desktop and server computer components that may be employed for implementing the present invention. For purposes of discussion, the following description will present examples in which it will be assumed that there exists a “server” (e.g., network access server) that communicates with one or more “clients” (e.g., personal or laptop computers such as the above-described system 100). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

Overview of Invention

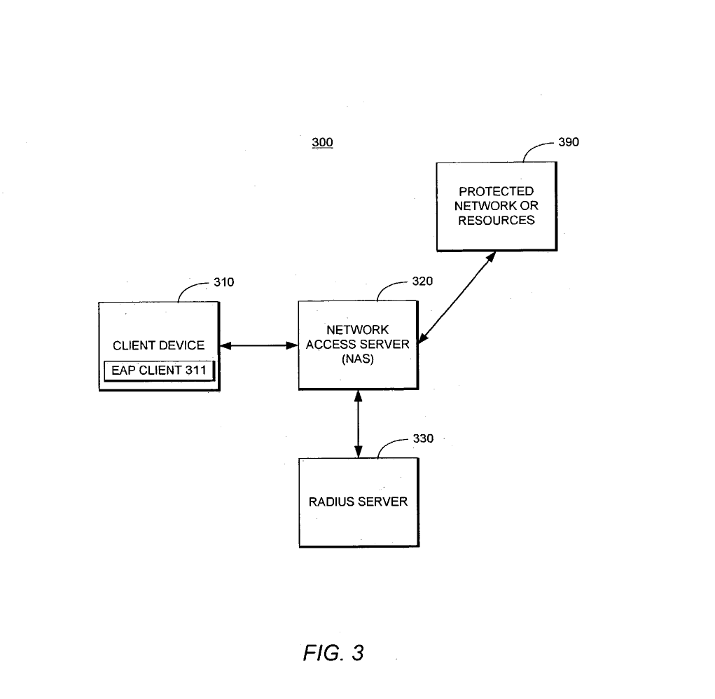

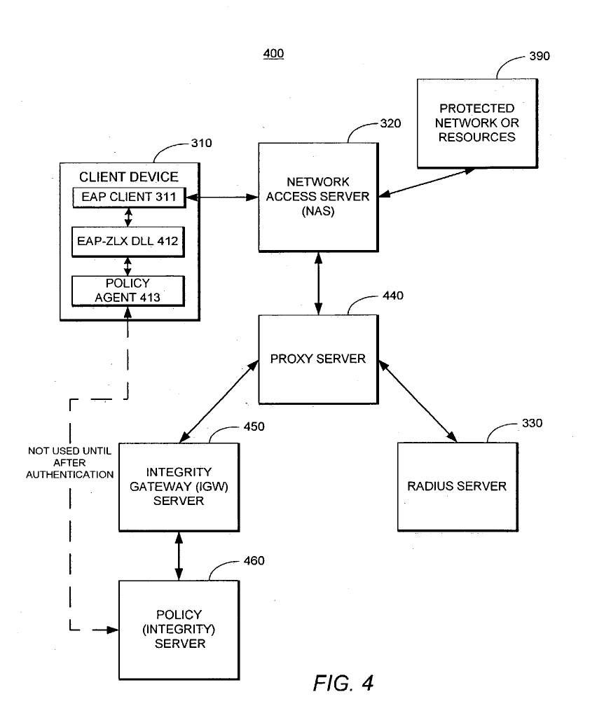

FIG. 3 is a block diagram of an exemplary network access server environment 300 illustrating the basic architecture of a network access system environment which includes a RADIUS server providing authentication services. As shown at FIG. 3, a client device 310 requesting access to a protected network 390 (e.g., the Internet, a corporate LAN or other resources) typically connects to a network access server (NAS) 320 using client software and/or hardware such as a VPN client, a PPP dialer, or the like. The NAS 320 acts as an access point (i.e., gateway) to a group of resources or collection of data (e.g., the protected network or resources 390) and accepts requests for access to such resources from client machines. When the NAS receives a request for access to the protected network 390 (e.g., from the client device 310 in this example), the NAS 320 typically requires the client to be authenticated before the client is permitted to access the network. Upon receiving a request for access, the NAS 320 operates in conjunction with a RADIUS server (primary RADIUS server) 330 to authenticate the client device 310. Although a single client device 310 is shown for purposes of illustration, the NAS 320 usually provides network access to a plurality of client devices. The client device 310 is typically a personal computer, laptop computer, or other client device attempting to access a network through the NAS 320. However, client devices which may connect to the NAS 320 may also include another network access server which connects to the NAS 320 for the purpose of securely linking together two networks. In addition, although the following discussion uses the example of a network access server to illustrate the operations of the present invention, the methodology of the present invention may also be used with web servers or other types of host devices in order to regulate access to protected applications, systems, and resources.

As also shown at FIG. 3, an EAP (Extensible Authentication Protocol) client 311 on the client device 310 communicates with the RADIUS server 330 through the NAS 320. The EAP client 311 on the client device 310 is a module that communicates with an authenticator (e.g., the RADIUS server 330) using the Extensible Authentication Protocol (EAP) in order to authenticate the client device 310 for network access. EAP is an extension to the Point-to-Point Protocol (PPP) developed in response to a demand for remote access user authentication that supports a number of different authentication schemes, including token cards, one-time passwords, public key authentication using smart cards, certificates, and the like. The exact authentication scheme to be used in a given situation is negotiated by the remote access client (i.e., the EAP client 311) and the authenticator (e.g., the RADIUS server 330). The communications between the EAP client 311 and the RADIUS server 330 include requests for authentication information from the RADIUS server and responses by the EAP client. For example, when EAP is used with security token cards, the authenticator may separately query the client for a name, PIN, and card token value. Authentication of the client is conditioned upon satisfactorily answering each of these questions.

Currently, most network access servers work in conjunction with RADIUS servers for client authentication. The RADIUS servers provide authentication, authorization, and accounting services for various types of NAS, including switches, remote access devices, wireless access points, firewalls, and virtual private networks (VPNs). RADIUS servers which may be used in conjunction with the present invention include Steel Belted Radius from Funk Software of Cambridge, Mass. and Internet Authentication Service (IAS) from Microsoft Corporation of Redmond, Wash. In this exemplary environment, when a request for access is received from the client device 310, the RADIUS server 330 performs various steps to verify that the client is authorized to access the protected network 390 (e.g., through user login and supply of a password) before a session is established.

The authentication process typically involves obtaining identity and authentication information from the client device 310 using the Extensible Authentication Protocol (EAP). In response to one or more challenges issued when the client device 310 connects to the NAS 320, the EAP client 311 on the client device 310 attempts to collect appropriate authentication information into one or more EAP packets and forwards these EAP packets to the NAS 320 over the established data link between the client device 310 and the NAS 320. The NAS 320 then encapsulates the identity and authentication information in a RADIUS access request packet and sends this packet to the RADIUS server 330. The RADIUS server 330 checks the client authentication information and decides whether to permit the client to access the network. The NAS 320 permits or denies access to the client based upon the response RADIUS packet received from the RADIUS server 330. If the client device 310 is not authenticated (e.g., password supplied is incorrect), then the RADIUS server 330 returns an Access-Reject message to the NAS 320 and the session is denied. On the other hand, if the client is authenticated, the RADIUS server 330 returns an Access-Accept message. The RADIUS server 330 may also return attributes in the Access-Accept message that specify what type of authorization the user will have on the network. For example, a “Filter-ID” attribute may be used to specify a set of internal network addresses that the user may be permitted to access, while also indicating that access to other internal network addresses should be blocked.

The present invention leverages the existing operations and infrastructure of the NAS and RADIUS server in order to extend security policy enforcement across an organization, ensuring that all devices connecting to a network comply with and enforce applicable security policies. In addition to authenticating the identity of users and ensuring that a secure connection is established to the network through use of the NAS infrastructure and the Extensible Authentication Protocol (EAP) as described above, the system and method of the present invention provide protection against malicious attacks (e.g., “Spyware” and “Trojan Horse” attacks) and virus intrusions by blocking network access to machines that do not meet required security and anti-virus standards (including, for example, policies, rules, or the like). For example, the present invention allows a corporate system administrator to require up-to-date anti-virus protection be in place on a client device before the device is allowed remote VPN access to a corporate network.

In an environment in which the present invention is implemented, the same initial steps described above are applicable. A client device establishes a data link-layer communication with a NAS in the same manner as for any ordinary NAS session. The data link-layer is the layer at which blocks of data are reliably transmitted over a transmission link as defined in the OSI (Open Systems Interconnection) Reference Model. The OSI Reference Model is a logical structure for communication systems standardized by the International Standards Organization (ISO) as ISO/IED standard 7498-1:1994: “Information technology—Open Systems Interconnection—Basic Reference Model: The Basic Model,” available from the ISO. When a connection to the NAS is established and a request for access to a network is received, the approach of the present invention is to provide for an extended set of EAP protocol communications with the client device. The present invention takes advantage of the extensibility of EAP by extending EAP to support policy-based authentication systems. More particularly, an extended EAP protocol (referred to as EAP-ZLX) is utilized to provide support for endpoint security negotiation in addition to typical authentication services. During the authentication process, a client device that supports the policy based authentication system of the present invention collects and sends not only the normal EAP packets required for authentication of the client device, but also provides additional information regarding the security mechanisms and policies in effect on the client device.

As part of the authentication process, the client device provides an EAP identity-response packet to the NAS. On receiving the EAP identity-response packet, the NAS constructs a RADIUS Access-Request packet with the EAP identity-response packet. This RADIUS Access-Request packet is sent to the proxy server which forwards the packet to the primary RADIUS server for authentication. As described in more detail below, the proxy server unwraps the packets and passes on the data, information, or EAP packet (e.g., EAP-MD5) incorporated therein to the appropriate destination (e.g., the primary RADIUS server) for handling. The proxy server provides the basic EAP authentication information (e.g., basic EAP packet(s) containing user name and password) to a primary RADIUS server to determine whether or not to authenticate the client. For example, in response to the Access-Request packet received from the proxy server the primary RADIUS server typically issues an Access-Challenge RADIUS packet. As described below, a number of challenges and responses may be exchanged as part of the authentication process.

In the presently preferred embodiment, the proxy server also operates in conjunction with a policy server (sometimes-referred to herein as an “integrity server”) and an integrity gateway (IGW) server for determining whether or not the client is in compliance with applicable security policies. Although the currently preferred embodiment employs a policy server which is referred to as an “integrity server”, a number of other alternative types of policy servers may also be employed as hereinafter described. The primary RADIUS server checks the user authentication information to determine whether or not to permit the user to access the network. If the client session is approved by the primary RADIUS server, additional policy information is obtained by the proxy server and reviewed (e.g., by the integrity server or another type of policy server) to determine whether the client device is in compliance with applicable security policies. The policy server then approves or denies the session based upon the user's compliance with applicable security policies as hereinafter described. The components of an exemplary network access server environment in which the present invention may be implemented will now be illustrated in greater detail.

System Components

FIG. 4 is a block diagram of an environment 400 in which the present invention is preferably embodied. As shown, environment 400 includes at least one client device 310, a network access server (NAS) 320, a RADIUS server 330, a protected network (or resources) 390, a proxy server 440, an integrity gateway (IGW) server 450, and a policy (or integrity) server 460. This example references a single client device 310 for purposes of illustration; however, a plurality of client devices typically connect to the NAS 320 from time to time. As shown, an EAP client 311, an EAP-ZLX extension DLL 412, and a policy (or integrity) agent 413 are installed on client device 310.

As previously described, a client device 310 connects to the NAS 320 to access the protected network or resources 390. The NAS 320 is responsible for creating a session to connect the client device 310 to the protected network 390. In the first phase of this process, the NAS 320 works in conjunction with an EAP client 311 on the client device 310 and the RADIUS server 330 to authenticate the session as previously described. However, in this situation the approach of the present invention is to provide for an extended set of EAP protocol communications with the client device 310. The present invention takes advantage of the ability to extend the EAP protocol by extending it to support policy-based authentication. Both client-side and server-side components are used to provide support for endpoint security negotiation in addition to typical authentication services.

The client-side components of the present invention include the EAP-ZLX extension DLL 412 and the policy (integrity) agent 413. The EAP-ZLX extension DLL 412 is an implementation of the EAP protocol that is utilized to provide support for security policy negotiation and enforcement. More particularly, the EAP-ZLX extension DLL 412 communicates with another client-side component of the present invention referred to herein as a policy agent (or integrity agent) 413 to retrieve information about the current security policy in operation on the client device 310. The information collected by the policy agent 413 is then packaged by the EAP client 311 together with material from other EAP dynamic link libraries (e.g., standard EAP Access-Request packet for a particular authentication mechanism) and sent to the NAS 320 for handling by the server-side components of the present invention. It should be noted that if the client device 310 does not include support for the EAP-ZLX protocol (e.g., because the client-side components of the present invention are not installed), then normal authentication of the client can proceed if the NAS 320 and primary RADIUS server 330 are configured to permit authentication to proceed, but the session will usually be denied access or granted restricted access as described below.

The server-side components of the currently preferred embodiment of the present invention include the proxy server 440, the IGW server 450, and the policy (integrity) server 460 in addition to the network access server (NAS) 320 and the RADIUS server 330. Many network access server environments include a proxy server (e.g., a RADIUS proxy server) for handling a number of different activities. For example, a proxy server may keep track of which users are logging on to a given network. Of particular interest to the present invention, as the client device 310 is being authenticated, the proxy server 440 receives (or traps) communications between the EAP client 311 and the RADIUS server 330 that are of interest for policy enforcement.

The IGW server 450 acts as a bridge for translating communications between the EAP client 311 and the RADIUS server 330 for authentication of the client device 310 into a format that is understood by the policy server 460. In the presently preferred embodiment, the proxy server 440 and the IGW server 450 are installed on the same machine; however these components may also be installed on separate machines. The IGW server 450 receives communications between the RADIUS server 330 and the EAP client 311 (e.g., communications which are trapped and forwarded by the proxy server 440), and translates these communications from RADIUS format into a protocol language referred to as the “Zone Security Protocol”, or “ZSP”. The ZSP is a communication protocol which enables a gateway device (such as the NAS) to announce to the policy server 460 that new sessions are being created. The policy server 460 may then act on these communications to determine whether or not the client device 310 is in compliance with applicable security policies as hereinafter described. The policy server 460 also uses the ZSP protocol to send messages back to the NAS 320 through the IGW server 450. For example, the policy server 460 may send a message instructing the NAS 320 that a particular session should be restricted (e.g., only permitted to access a certain set of addresses), or disconnected.

The policy server 460, which supports the methods of the present invention, ensures that all users accessing a particular system or network comply with specified security policies, including access rights and cooperative anti-virus enforcement. The policy server 460 includes a repository (not shown) that stores security policies and rules as well as related information. The policy server 460 may store multiple security policies applicable to a number of different individuals or groups. In response to a message from the IGW server 450 (or a subsequent message from the policy agent 413 on the client device 310), the policy server 460 evaluates whether or not the client device 310 has a correct, up-to-date version of the applicable security policy. The policy server 460 also serves in an enforcement role. In the event a client device does not have the correct policy loaded or the policy server 460 detects some other problem, it may instruct the NAS 320 to deny network access to a client device.

The policy server 460 may enforce a variety of different types of security policies or rules. These security policies may include, for instance, rules which require client devices connecting to a given network to be using particular security or anti-virus programs. For example, a system administrator may establish a policy requiring that a specific virus protection program is operational on each client device that is connected to a network. The policy server would then evaluate whether or not each client device was in compliance with the specified policy before approving the client device for network access. The security policies enforced by the policy server 460 may also include application permission rules. For example, an administrator can establish a rule based on a particular application identity (e.g., name and version number), such as a rule preventing access to particular resources by a RealAudio player application (e.g., “ra32.exe”) or a rule permitting access to only administrator or user-approved applications. Similarly, an administrator can establish a rule requiring a particular application to have a verifiable digital signature. Apart from application-based rules, policies can be established on the basis of non-application activities or features. For example, rules can also be established on the basis of including and/or excluding access to particular Internet sites. These security policies can be customized by a user or administrator and a multitude of different types of policy rules can be established and enforced, as desired. Further information regarding the establishment and enforcement of security policies is provided in commonly-owned application Ser. No. 09/944,057 (Docket No. VIV/0003.01), filed Aug. 30, 2001, entitled “System Providing Internet Access Management with Router-based Policy Enforcement,” the disclosure of which is hereby incorporated by reference in its entirety, including any appendices or attachments thereof, for all purposes.

In the currently preferred embodiment, the policy server 460 is installed on a different machine than the IGW server 450. However, the policy server 460 may also be installed on the same machine as the IGW server 450. Those skilled in the art will appreciate that the system and methods described herein may also be used in a number of different configurations for implementing the present invention. For instance, the functionality of the present invention may also be advantageously incorporated as part of a network access server, a RADIUS server, a combination of a RADIUS server augmented through third-party extension DLLs, and/or a proxy server. When the policy server 460 receives notice of a connection to the NAS 320 for establishment of a network session, the policy server 460 evaluates whether or not the client making the request (e.g., client device 310) should be permitted to access the protected network 390 under applicable security policies. More particularly, in response to the message received by the proxy server 440 and translated by the IGW server 450, the policy server 460 determines whether the client device 310 complies with applicable rules (i.e., policy requirements). In the currently preferred embodiment, the security and behavioral policies that are cooperatively enforced by the policy server include end point firewall policies, application network access policies, e-mail defense options, and anti-virus protection policies.

In the currently preferred embodiment, security and behavioral policy definition and enforcement (e.g., definition and enforcement of firewall, network access, and anti-virus policies) are provided by the TrueVector engine available from Zone Labs, Inc. and described in further detail in commonly-owned U.S. Pat. No. 5,987,611, entitled “System and methodology for managing Internet access on a per application basis for client computers connected to the Internet,” the disclosure of which is hereby incorporated by reference. Further description of a rules engine component for security and behavioral policy definition and enforcement is provided in commonly-owned application Ser. No.10/159,820 (Docket No. VIV/0005.01), filed May 31, 2002, entitled “System and Method for Security Policy Arbitration,” the disclosure of which is hereby incorporated by reference in its entirety, including any appendices or attachments thereof, for all purposes.

The policy server 460 works cooperatively with other server-side components to enforce applicable security requirements. The policy server 460 ensures that a client receives no access to sensitive information if the client's security policy is not properly in place, and yet permits sufficient access to the internal network to allow downloading the required security modules and policies. To provide cooperative enforcement, the policy server makes use of the authorization capabilities of the NAS and RADIUS server to restrict an access session. In the currently preferred embodiment, the policy server 460 can advise the NAS 320 to restrict access to the protected network 390 (e.g., using a “Filter-ID” attribute, or similar attribute, as described above) or to permit the requested access. The rules enforced by the policy server 460 may also be changed from time to time by a user or administrator (e.g., in response to certain events, such as a threat from a serious virus that has been released and is “in the wild”). For example, a network administrator may require all users accessing the network to implement a virus definition update (e.g., DAT file) that is targeted at a particular virus. Thus, the administrator may implement a virus-definition update in a manner that is much more efficient than sending a broadcast message to all users informing them of the need to update their virus protection programs.

Operations of Proxy Server and IGW Server

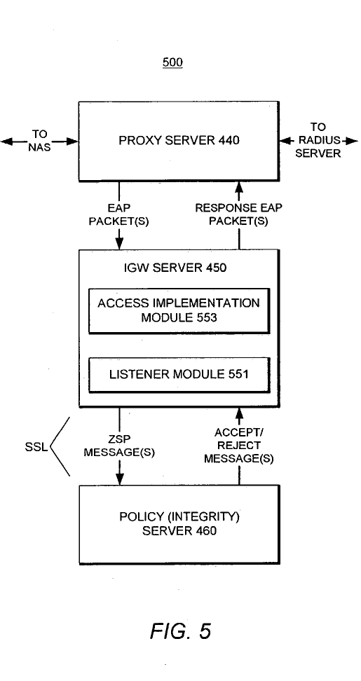

FIG. 5 is a block diagram illustrating the operations of the proxy server 440 and the IGW server 450 in greater detail. The proxy server 440 and IGW server 450 operate to detect and route communications of interest to the policy server 460 to enable the policy server 460 to enforce policy requirements. As previously described, in response to an authentication challenge a client device (e.g., client device 310) collects and sends EAP packets containing authentication information to the NAS 320. The NAS 320 then encapsulates this information in a reply RADIUS Access-Challenge message and sends it to the RADIUS server 330. If the authentication information is correct (e.g., password is correct), the RADIUS server 330 sends an Access-Accept packet which is trapped by the proxy server 440. It should be noted that in many EAP implementations, authentication of a client device frequently requires multiple rounds of EAP packets being sent back and forth before the authentication process is completed.

In the presently preferred embodiment information such as the Access-Accept packet is trapped (or otherwise received) by the proxy server 440 which communicates with the IGW server 450 and the policy server 460. However, the RADIUS server may alternatively communicate directly with the IGW server 450 and/or the policy server 460 (see e.g., “alternative embodiments” discussion below). As one alternative example, the RADIUS server can expose an API interface that would allow interested parties (e.g., the IGW server or the policy server) to register an interest in particular communications by registering a callback function. The following description uses an example in which certain communications between the client device 310 and the RADIUS server 330 are trapped; however those skilled in the art will appreciate that there are a number other ways that client authentication information may be made available to the IGW server 450 and the policy server 460.

Although the currently preferred embodiment employs a policy server which is referred to as an “integrity server”, a number of other alternative types of policy servers may also be employed. For example, the RADIUS server may communicate with a “KeyNote” server, rather than an integrity server, to provide policy enforcement. For further information regarding KeyNote servers, see e.g., “RFC 2704: The KeyNote Trust Management System Version 2,” available from the IETF, the disclosure of which is hereby incorporated by reference. A copy of RFC 2704 is currently available from the IETF via the Internet at www.ietf.org/rfc/rfc2704.txt. As yet another alternative example, the RADIUS server can be constructed and configured to enforce some or all of the policy rules that the policy server can enforce, thereby removing the need to use an external policy server for policy enforcement. Those skilled in the art will appreciate that a number of other configurations may be used for providing policy enforcement. For example, a RADIUS server may handle certain matters while invoking an external policy server in other situations, depending on such factors as the complexity of the decision-making process and the performance impact of consulting an external policy server.

The proxy server 440 listens for and traps (or otherwise receives) specific types of messages, including particularly RADIUS Access-Accept packets sent by the RADIUS server. Other techniques (besides trapping) may be also employed, if desired, for redirecting the challenge. When an Access-Accept packet is received, the proxy server 440 proceeds to issue a policy challenge to the client device 310 (not shown at FIG. 5). The client generates and sends a response to the policy challenge as described below. The response to the policy challenge received from the client device 310 is routed to the policy server 460 via the proxy server 440 and IGW server 450 as shown at FIG. 5. The IGW server 450 translates communications received by the proxy server 440 and passes these communications to the policy server 460. In the currently preferred embodiment, the proxy server 440 and the IGW server 450 are on the same machine; however those skilled in the art will appreciate that these components may also be installed on different machines or in a number of other configurations.

Of particular interest, when the proxy server 440 receives an EAP Access-Accept packet from the RADIUS server 330 for a given client (e.g., client device 310), the proxy server 440 issues a policy challenge to the client. The policy challenge may, for example, request the policy MD5 of the policy located on the client device. The client responds to the policy challenge by collecting the requested policy information, converting the policy information into raw bytes of EAP data, and forming an extended EAP packet containing this raw data as hereinafter described. The client then sends this extended EAP packet in response to the policy challenge. When a response to this policy challenge is received from the client, the proxy server 440 passes this information to the access implementation module 553 of the IGW server 450. The access implementation module 553 unpacks the client-supplied extended attributes contained within the response packet and translates this security policy information regarding the client device 310 into Zone Security Protocol (ZSP) message format. The access implementation module 553 passes the information to the policy server 460 as well formed messages (e.g., “IGW_QUERY” messages) as defined by the ZSP used for communication with the policy server 460. These messages include the data contained within the EAP packet sent by the client in response to the policy challenge. The information received by the policy server may, for example, include the policy MD5 of the policy on the client device and/or other relevant information required to determine the client's compliance status. As shown at FIG. 5, the IGW server 450 includes a listener module 551 which listens for communications from the policy server 460. In the currently preferred embodiment, the policy server 460 and the listener module 551 communicate through an authenticated Secure Sockets Layer (SSL) connection. As shown, messages are sent to and received from the policy server 460 by the listener module 551.

Upon receipt of the ZSP messages containing policy information from the IGW server 450, the policy server 460 evaluates the information that is received to determine whether or not the client is in compliance with applicable rules and requirements. After the policy server 460 has made this determination, it returns a response message to the IGW server 450 indicating whether to approve or deny the session (i.e., accept or reject the request for network access by the client). Alternatively, the policy server may restrict a session to limited access (e.g., a set of IP addresses) rather than deny access completely. If the session is approved an “ISS_AUTH_OK” message is sent to the IGW server 450. Otherwise, to restrict the session the policy server sends back an “ISS_AUTH_RESTRICT” message to the IGW server.

When the access implementation module 553 on the IGW server 450 receives the response message from the policy server 460, the access implementation module 553 formulates a RADIUS Access-Accept package for transmission by the proxy server 440. In the currently preferred embodiment, if the client does not have the correct security policy in place, the RADIUS packet that is generated for return includes a restrictive filter identifier that limits access for the session to a limited group of IP addresses (i.e., a defined “sandbox” area). In this event the NAS limits access by the client device to this limited group of IP addresses and does not permit the client device to access other resources. A user of a non-compliant client device is also typically informed of the need for remediation. The user can then use a web browser to download and install any required software from a software deployment (“sandbox”) web server to remedy the non-compliance. Further description of a “sandbox” web server for assisting users in remedying non-compliance is provided in commonly-owned application Ser. No. 09/944,057 (Docket No. VIV/0003.01), filed Aug. 30, 2001, entitled “System Providing Internet Access Management with Router-based Policy Enforcement,” the disclosure of which is hereby incorporated by reference in its entirety, including any appendices or attachments thereof, for all purposes. The restrictive filter that is applied is structured to allow access to this web server, while restricting access to other network resources. After the user has downloaded the required software, the user may then attempt to re-authenticate to obtain network access.

Alternatively, if the NAS supports the ability to remove the restrictive filter, then the IGW server can direct the NAS to remove the restrictive filter once the client has established compliance with the required policy. When the client has taken the necessary steps to comply with the policy, the policy server is notified by the client (e.g., through an “IA_HEARTBEAT” message, which is a periodic status message sent from the client directly to the policy server). If the policy server verifies that the client is indeed in compliance with the assigned policy, it sends an “ISS_AUTH_OK” message to the IGW server to indicate that the session should be unrestricted. In response to receiving the “ISS_AUTH_OK” message from the policy server, the IGW server directs the NAS to remove the restrictive filter. The particular method for directing the NAS to remove the restrictive filter may vary somewhat depending on the specific NAS (or other host) that is employed and may require an API function to be called, a data packet message to be sent, or another method. Two different types of EAP packets used for transmission of data between the various client-side and server-side components will now be explained in greater detail.

Basic Description of EAP Packets

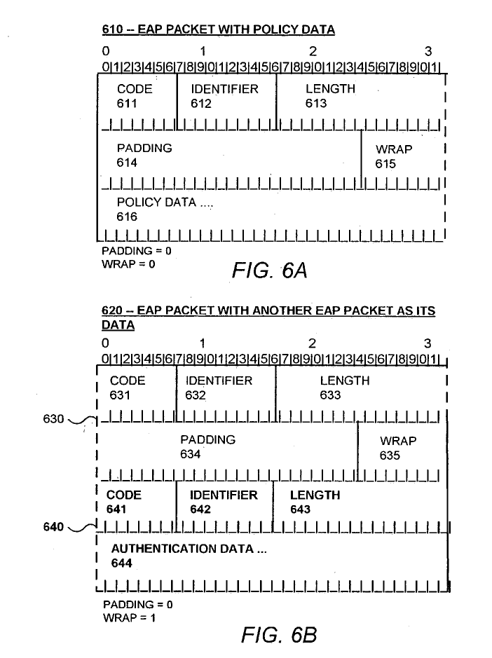

FIG. 6A illustrates an (unwrapped) EAP packet 610 containing policy data. A single EAP packet 610 is usually encapsulated in the information field of a data link-layer frame where the protocol field indicates that the packet is a PPP EAP type. As shown at FIG. 6A, the EAP packet 610 contains the following fields: a code field 611, an identifier field 612, a length field 613, a padding field 614, a wrap field 615, and a data field 616. The fields are transmitted from left to right. The code field 611 is typically one octet and identifies the type of EAP packet. EAP codes are assigned as follows: 1=Request; 2=Response; 3=Success; and 4=Failure. The identifier field 612 is also typically one octet and aids in matching responses with requests. The length field 613 is usually two octets and indicates the length of the EAP packet including the code 611, identifier 612, length 613, padding 614, wrap 615, and data 616 fields. The value of the wrap field 615 is zero, to indicate this is an unwrapped packet. Octets outside the range of the length field are generally treated as data link layer padding and are ignored on reception.

This type of unwrapped EAP packet illustrated at FIG. 6A is used for transmission of information from the client device to the proxy server as a response to the challenge for policy information. If the client-side components of the present invention are in operation on the client device, the EAP response packet generated on the client device in response to a policy challenge will contain policy information regarding the security mechanisms in effect on the-client device. In the currently preferred embodiment, this policy data comprises an Extensible Markup Language (XML) message that contains information needed to determine the security policy, anti-virus definitions, and other such security measures in effect on the client device. The XML message may be cryptographically signed using the XML signature standard or another digital signature method. For further information regarding XML signature standard, see e.g., “RFC 3275: (Extensible Markup Language) XML-Signature Syntax and Processing” available from the IETF, the disclosure of which is hereby incorporated by reference. A copy of RFC 3275 is currently available via the Internet at www.ietf.org/rfc/rfc3275.txt. As an alternative example, the policy data can comprise one or more cryptographic certificates.

FIG. 6B illustrates a wrapped EAP packet 620 comprising an EAP packet 630 which contains another EAP packet 640 as its data. As shown, EAP packet 640 (indicated by bolding at FIG. 6B) is embedded within the data field of an EAP packet 630. In other words, the EAP packet 630 serves as a wrapper for the EAP packet 640. EAP packet 630 includes a code field 631, an identifier field 632, a length field 633, a padding field 634, and a wrap field 635. The code field 631, identifier filed 632, and length field 633 of EAP packet 630, and the code field 641, identifier field 642, length field 643, and data field 644 of embedded EAP packet 640 are the same as described above for (unwrapped) EAP packet 610. The value of the wrap field 635 is one, to indicate this is a wrapped packet. This wrap field 635 also includes a code which enables the proxy server to identify where to send the embedded EAP packet 640. In the currently preferred embodiment, the proxy server typically handles a wrapped EAP packet such as this exemplary EAP packet 620 by unwrapping the packet and forming a new message containing the embedded packet (e.g., EAP packet 640) in a format appropriate for transmission to the appropriate destination (e.g., the primary RADIUS server).

Detailed Methods of Operation

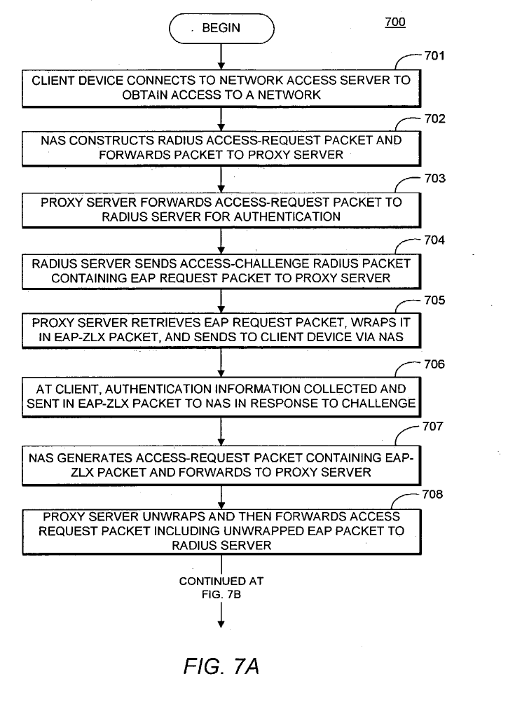

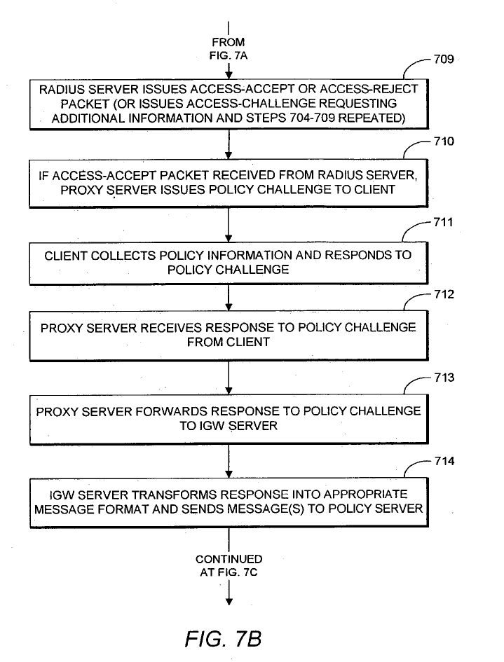

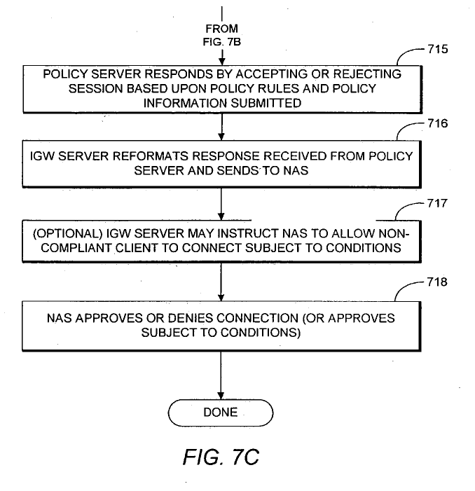

FIGS. 7A-C comprise a single flowchart 700 illustrating the high-level methods of operation of the system of the present invention in policy enforcement. The following description presents method steps that may be implemented using computer-executable instructions, for directing operation of a device under processor control. The computer-executable instructions may be stored on a computer-readable medium, such as CD, DVD, flash memory, or the like. The computer-executable instructions may also be stored as a set of downloadable computer-executable instructions, for example, for downloading and installation from an Internet location (e.g., Web server).

Although the following discussion uses wireline (e.g., dial-up, ISDN, DSL, cable modem, T1, or the like) connection to an NAS as an example, the same approach may also be used for clients connecting to a network through a wireless access point.

Connecting to a network through a wireless access point that implements IEEE (Institute of Electrical and Electronics Engineers) 802.1x closely resembles the process of logging in to a network via a wireline connection to a NAS. Accordingly those skilled in the art will appreciate that the methodology of the present invention is not limited to wireline access to a network, but may also be advantageously employed in other environments, including wireless environments.

The method begins at step 701 when a client device connects to a network access server in an attempt to obtain access to a network. The user of the client device typically negotiates a link layer protocol to establish a network link connection using gateway client software installed on the client device. This gateway client software may be a VPN client, a PPP dialer, or similar software installed on the client device. Once the link is established with the network access server, authentication proceeds. As part of the authentication process, the client device provides an EAP identity-response packet to the NAS. On receiving the EAP identity-response packet, at step 702 the NAS constructs a RADIUS Access-Request packet with the EAP identity-response packet as an attribute and forwards the Access-Request packet to the proxy server.

At step 703, the proxy server forwards the Access-Request packet to the primary RADIUS server for authentication. In response to the Access-Request packet, at step 704 the primary RADIUS server issues an Access-Challenge RADIUS packet. The RADIUS Access-Challenge packet contains a challenge in the form of an EAP request packet. This RADIUS Access-Challenge packet is sent to the proxy server. At step 705, the proxy server retrieves the EAP request packet contained in the RADIUS Access-Challenge packet and wraps it with another EAP packet type (specifically, an EAP-ZLX type packet) and sends the (wrapped) EAP packet in a RADIUS packet to the NAS. The NAS is responsible for extracting the EAP packet from the RADIUS packet and forwarding it to the client device using the established link layer protocol.

In response to the challenge, at step 706 the client which receives the challenge (e.g., the EAP client software on the client device) collects appropriate authentication information and provides this information to the NAS. As part of this process, the client device loads the EAP client software (e.g., an EAP extension dynamic link library (DLL) of the required sub-type) for retrieving authentication information and generating a response to the challenge. After this authentication information has been collected, a wrapped EAP packet (EAP-ZLX type EAP packet) containing the authentication information (e.g., user identification and password) is generated and sent in reply to the challenge over the established data link.

On receiving the EAP packet from the client device, at step 707 the NAS generates a RADIUS Access-Request packet containing the EAP-ZLX packet and forwards it to the proxy server for authentication. On determining that the EAP packet is a wrapped packet, at step 708 the proxy server unwraps it and forwards the EAP packet that was wrapped in the EAP-ZLX packet in an Access-Request RADIUS packet to the primary RADIUS server for authentication.

In response to the Access-Request packet, at step 709 the primary RADIUS server generates a RADIUS Access-Accept packet (if the authentication information provided by the client device is valid), an Access-Reject packet (if the authentication information is incorrect), or another Access-Challenge packet (if the authentication process is incomplete and requires more information to be gathered from the client). In a case where the primary RADIUS server generates a RADIUS Access-Challenge packet to obtain more information from the client, steps 704 to 709 are repeated until the primary RADIUS server has gathered enough information from the client to make a decision to accept or reject the connection. When the primary RADIUS server has sufficient information it makes a decision and issues a RADIUS Access-Accept or Accept-Reject packet. The Access-Accept or Access-Reject RADIUS packet is then forwarded to the proxy server. If the proxy server receives an Access-Accept packet from the primary RADIUS server, at step 710 the proxy server proceeds to issue a policy challenge to the client device. The proxy server issues the policy challenge (e.g., in an unwrapped EAP packet) to obtain information about the policies in effect on the client device. Otherwise, if an Access-Reject RADIUS packet is received by the proxy server (e.g., because the client authentication information is incorrect), the Access-Reject packet is forwarded to the NAS. However, assuming that the client is authenticated by the RADIUS server, the NAS forwards the policy challenge received from the proxy server to the client device.

Upon receipt of the policy challenge, at step 711 the client collects policy information and responds to the policy challenge. On the client device, an EAP-ZLX dynamic link library (DLL) is invoked to obtain the required policy information and to generate a response packet including the policy information. In the currently preferred embodiment, the EAP-ZLX DLL calls an application programming interface of the local TrueVector security service on the client device to query the policy state and machine state, and a login message in XML format containing the policy information is generated and is packaged inline in an (unwrapped) extended EAP Packet (of type EAP-ZLX) for transmission to the proxy server (and ultimately to the policy server). The response packet that is generated is then sent from the client in reply to the policy challenge.

At step 712, the proxy server receives the response to the policy challenge from the client device. At step 713, the proxy server determines that the EAP packet received from the client device is a response to the policy challenge and forwards the response to the IGW server. At step 714, the IGW server transforms (i.e., converts) the response into a message having a format that is appropriate for transmission to the policy server using the ZSP protocol. In the currently preferred embodiment, the IGW server translates the response into one or more “IGW_QUERY” messages. The messages(s) are then sent to the policy server.

At step 715, the policy server accepts or rejects (i.e., approves or restricts) the session based on the applicable policy rules and the policy information submitted by the client. If the Access-Request packet does not indicate that the proper EAP negotiation was available, then the client is usually treated as if it is not in compliance with policy requirements. This may happen if the client does not have the required software installed enabling the client to negotiate the EAP-ZLX protocol. If the session is to be allowed, the policy server sends back an “ISS_AUTH_OK” message to the IGW server. However, in the currently preferred embodiment, if the client is not in compliance with policy requirements the policy server returns a message to the IGW server indicating that access is to be denied (or restricted). At step 716, the IGW server reformats the response message received from the policy server (e.g., as a RADIUS packet) and passes the reformatted response back to the NAS.

At (optional) step 717, if the client is not in compliance with the policy requirements, the IGW server may return an Access-Accept RADIUS packet to the NAS that includes a restrictive filter message (or filter ID) for application by the NAS of a filter which permits the client to connect, but subject to additional constraints or conditions. For example, access for the session may be permitted only to a limited group of IP addresses (i.e., a designated “sandbox” area). In addition, a packet may be returned to the client device which contains configuration information for the policy server (e.g., the policy server's IP address and port). The packet may contain a message to be displayed to the user, which can serve as a launching point for remediation (i.e., upgrading software or policies) by the client. This message may, for example, advise the client that he or she can use a web browser to download and install any required software from a software deployment (“sandbox”) web server. The restrictive filter that was returned in the packet to the NAS typically allows access to this web server for remediation. From the “sandbox” web server, the end-user can download the proper software and version and then re-authenticate to establish proper security credentials. In contrast, if the client does have the correct policy, the packet that is returned to the NAS will typically permit full access to the network. At step 718, the NAS approves or denies the connection requested by the client device (or approves subject to conditions or restrictions). Once the authentication and authorization steps are completed, the NAS completes the link initiation and the normal network flow continues. If the session was given a restricted filter, then access is restricted to the “sandbox” server or area.

As another alternative to the accept or reject approach described above, the Access-Accept packet that is returned to the NAS may assign a session-timeout value (i.e., only authenticate the user for a given period of time) and require re-authentication at an appropriate time interval (e.g., via a heartbeat message from the client device directly to the policy server as previously described). In this event when the session times out due to the session-timeout attribute that was returned to the NAS, the NAS starts the authentication/authorization procedure again.

Detailed Internal Operation

Request for Access and Initiation of Client Authentication

The following will describe in greater detail the sequence of messages exchanged between the client device requesting a connection to the network and the server-side components in authenticating the client in the currently preferred embodiment. As previously described, the process begins when a client device connects to a network access server (NAS) to obtain access to a network. A client networking device establishes a link-layer communication with a Network Access Server (NAS) as with any ordinary NAS session, such as with dial-up (PPP or SLIP), and authenticated Ethernet or wireless (IEEE 802.11) technologies.

When a client device connects to the NAS, the NAS sends a RADIUS Access-Request/EAP start packet to the proxy server. The proxy server forwards this packet to the primary RADIUS server. This start packet comprises a message indicating that the NAS is requesting authentication for a session. In response to this start packet, the primary RADIUS server sends a RADIUS Access-Challenge/EAP identity-request packet back though the proxy server to the NAS. On receiving the Access-Challenge/EAP identity-request packet from the proxy server, the NAS extracts the EAP identity-request packet and sends it to the client device requesting the network connection.

Client Identity Response Generated and Sent to NAS

When the client device requesting the network connection receives the EAP identity-request packet from the NAS, the client device typically responds by sending an EAP identity-response packet. However, for implementation of the policy-based authentication system of the present invention, an extended EAP packet type is created. The contents of this extended EAP packet can either comprise another basic EAP packet (e.g., EAP-MD5 or EAP-OTP) or comprise regular data (e.g., data in XML format). The following “authenticate” method of the EAPClient30.java class illustrates this process in the currently preferred embodiment:

| | |
|---|---|
| 1: | EAPClient30.java |
| 2: | public void authenticate(byte[ ] name,byte[ ] |
| | password) throws EAPExc |
| 3: | { |
| 4: | int result; |
| 5: | ArrayList subElements = new ArrayList(1); |
| 6: | |
| 7: | String authInfo = CryptoManager.hash(“authInfo”); |
| 8: | String cxnSignature = CryptoManager.hash(“cxnSignature”); |
| 9: | boolean done = false; |
| 10: | |
| 11: | //Begin by sending the Identity Response Packet |
| 12: | |
| 13: | ExtendedEAPPacket packet = |
| | EAPMD5Handler.generateMd5IdentityResponse(nam |
| 14: | ExtendedEAPPacket epacket = |
| | new ExtendedEAPPacket(TYPE_30_MD5); |
| 15: | |
| 16: | AttributeList requestList = |
| | packet.createIdentityResponse(EAPPacket.crea |
| 17: | |
| 18: | result = send(requestList); |
| 19: | } |

As illustrated above, in the currently preferred embodiment the extended EAP packet comprises a basic EAP identity packet (of the type EAP-MD5) which is generated as shown at line 13 above. The basic EAP identity packet is wrapped with an extended EAP packet. The (wrapped) EAP packet is then sent to the NAS in response to the identity-request packet as illustrated at line 18.

Proxy Server Forwards Access Request to RADIUS Server

Upon receipt of the identity-response packet from the client, the NAS wraps the identity-response packet in an Access-Request RADIUS packet and forwards it to the proxy server (i.e., a proxy RADIUS server) in a manner typical of a standard NAS/RADIUS server session. The proxy server unwraps the Access-Request RADIUS packet to extract the extended EAP packet, which in turn is further parsed to obtain the basic type EAP packet as illustrated by the following “changeRequest” method from the ProxyServer.java class:

| | |
|---|---|
| 1: | ProxyServer.java |
| 2: | |
| 3: | // Change the proxy's attributes |
| 4: | |
| 5: | public void changeRequest(ProxyInfo prx) throws |
| | AccessDropException, |
| 6: | { |
| 7: | String realm = “radius.auth”; |
| 8: | try |
| 9: | { |
| 10: | int packetType = prx.getRequestType( ); |
| 11: | |
| 12: | //If the packet isn't for request just ignore it |
| 13: | if(packetType!=PacketType.Access_Request) |
| 14: | return; |
| 15: | |
| 16: | //Set the realm if it is to be proxied to the other radius server |
| 17: | |
| 18: | AttributeList ai = prx.getRequestAttributeList( ); |
| 19: | ExtendedEAPPacket ep = new ExtendedEAPPacket(ai); |
| 20: | packetId = ep.getPacketIdentifier( ); |
| 21: | |
| 22: | //Get the data from the EAPPacket in the form of a byte array |
| 23: | |
| 24: | byte[ ] data = ep.getData( ); |
| 25: | |
| 26: | |
| 27: | //Check to see if the secret code exists...if it does then set |
| 28: | //the realm and dispatch it to the target Radius Server |
| 29: | |
| 30: | if(ExtendedEAPPacket.checkSecretCode(data)) |
| 31: | { |
| 32: | //Remove the secret code and create a new EAP packet |
| 33: | |
| 34: | byte[] newData = ExtendedEAPPacket.removeSecretcode(data); |
| 35: | EAPPacket EAPPacket = new EAPPacket(newData); |
| 36: | prx.setTransparentProxy(realm); |
| 37: | |
| 38: | //Remove the original EAP packet from the attribute List and set |
| 39: | //the new packet |
| 40: | ai.delete(Attribute.EAP_Message); |
| 41: | |
| 42: | //Add the newly created EAP Packet to the Radius Attribute List |
| 43: | |
| 44: | ai.mergeAttributes(EAPPacket.toAttributeList( )); |
| 45: | |
| 46: | prx.appendResponseAttributes(ai); |
| 47: | } |

As shown at line 24 above, when an Access-Request packet is received, the proxy server extracts data from the packet. The wrap field within the extended EAP packet determines whether the extended packet data is another basic EAP packet or contains policy-specific data. As shown at lines 30-36, if the wrap field is equal to one, the proxy server unwraps the packet and forms a new EAP packet with an EAP attribute constructed from the identity-response information contained in the packet received from the client. This newly constructed EAP packet is then forwarded to the primary RADIUS server for authentication of the client.

Proxy Server Processes Access Challenge from RADIUS Server

The RADIUS server then evaluates the identity information contained in the EAP packet received from the proxy server. If the identity information contained in the EAP identity-response packet is recognized, the RADIUS server sends an Access-Challenge RADIUS packet to the proxy server. However if the identity is not recognized, the RADIUS server sends an Access-Reject packet. The proxy server receives the Access-Challenge packet from the (primary authentication) RADIUS Server and alters it as described in the following “changeResponse” method of the ProxyServerjava class:

| | |
|---|---|
| 1: | ProxyServer.java |
| 2: | |
| 3: | /** |
| 4: | * Change a proxy's response attributes...mainly acts on the |
| 5: | * response received from the target radius server |
| 6: | */ |
| 7: | |
| 8: | public void changeResponse(ProxyInfo prx) throws |
| | AccessDropException |
| 9: | { |
| 10: | AttributeList ai = null; |
| 11: | int packetType = prx.getRequestType( ); |
| 12: | try |
| 13: | { |
| 14: | //If the packet is of type Request ... an error and |
| | throw an AccessDropE |
| 15: | if(packetType == PacketType.Access_Request) |
| 16: | throw new AccessDropException(“Incorrect Packet Type”); |
| 17: | |
| 18: | ai = prx.getRequestAttributeList( ); |
| 19: | |
| 20: | if(packetType == PacketType.Access_Challenge) |
| 21: | { |
| 22: | //Get the EAP Packet from the Radius Attribute Block |
| 23: | ExtendedEAPPacket EAP = new ExtendedEAPPacket(ai); |
| 24: | |
| 25: | //Construct a new ExtendedEAP packet from this packet |
| 26: | |
| 27: | ExtendedEAPPacket ep = new |
| | ExtendedEAPPacket(TYPE_30_MD5); |
| 28: | |
| 29: | //save the type of the packet |
| 30: | int type = EAP.getType( ); |
| 31: | |
| 32: | //Delete the entire EAP message from the Radius Attribute |
| 33: | ai.delete(Attribute.EAP_Message); |
| 34: | |
| 35: | // Depending on the type of the extracted packet, generate either an |
| 36: | // identity response or challenge request |
| 37: | |
| 38: | |
| 39: | if(packetType == PacketType.Access_Challenge) |
| 40: | |
| 41: | ai.mergeAttributes(ep.createChallengeRequest(packetId,EAP)); |
| 42: | prx.appendResponseAttributes(ai); |
| 43: | prx.setResponseType(PacketType.Access_Challenge); |
| 44: | } |

The proxy server, on receiving the Access-Challenge packet from the RADIUS server, extracts the basic type EAP packet from the attribute list as shown at lines 18-23 above. The proxy server then constructs an extended EAP packet as indicated at line 27 and wraps the basic EAP packet within this extended EAP packet. The original EAP packet is now replaced by the extended EAP packet and forwarded to the NAS. Upon receipt, the NAS passes this wrapped EAP packet to the client in a manner that is typical for an ordinary NAS/RADIUS session.

Client Response to Access Challenge

When the client receives the Access-Challenge packet, the client processes the Access-Challenge and generates a response. This is illustrated by the following code from an “Authenticate” method of the EAP30Clientjava class:

| | |
|---|---|
| 1: | // |
| 2: | // Authenticate method of EAP30Client.java |
| 3: | zonelabs.integrity.core.provider.ProviderType.parse(“zonelabs”); |
| 4: | |
| 5: | while(!done) |
| 6: | { |
| 7: | if(result == PacketType.Access_Challenge) |
| 8: | { |
| 9: | //Check to see if it is not a proxy challenge |
| 10: | if(verify(result,getExtendedEAPPacket( ))) |
| 11: | result = send |
| | ( generate30MD5Challenge(getExtendedEAPPac |
| 12: | else // it is a proxy challenge |
| 13: | { |
| 14: | try |
| 15: | { |
| 16: | LoginMessage msg = new LoginMessage( |
| 17: | getSecurityProviderInfo( )); |
| 18: | result = send(generate30Challenge(getExtendedEAPPacket( ), |
| | msg.Mess |
| 19: | } |
| 20: | catch(Exception e) |
| 21: | { |
| 22: | e.printStackTrace( ); |
| 23: | } |
| 24: | } |
| 25: | } |
| 26: | |
| 27: | if(result == PacketType.Access_Reject) |
| 28: | { |
| 29: | print(“Authentication Failed”); |
| 30: | done = true; |
| 31: | } |
| 32: | else if (result == PacketType.Access_Accept) |
| 33: | { |
| 34: | print(“Authentication Succeeded”); |
| 35: | done = true; |
| 36: | } |
| 37: | } |
| 38: | } |

As in the case of the proxy server, the client is also responsible for extracting the extended EAP packet and determining if the data within the extended packet is another basic EAP packet or is policy type EAP data as illustrated at lines 7-12 above. The client does so by checking the wrap field. If the wrap field is equal to one, the basic EAP type packet is extracted and processed to form a response to the challenge. In addition, this basic EAP packet is wrapped with an extended EAP packet and sent in reply to the challenge as shown at line 18 above.

RADIUS Server Authentication of Client

The EAP packet sent by the client is processed by the proxy server in the same manner as previously described. The proxy server forms a new EAP packet with an EAP attribute constructed from the information contained in the packet received from the client. This newly constructed EAP packet is then forwarded to the RADIUS server. The RADIUS server, which acts as the primary authentication server, processes the response (i.e., the Access-Challenge response) sent by the client and generates an Access-Accept or Access-Reject RADIUS packet. When the response to the access challenge is received by the RADIUS server, the EAP packet is processed to verify the authenticity of the client. The RADIUS server may issue another Access-Challenge packet if the authentication process is incomplete and more information from the client is required. When the RADIUS server has sufficient information, it determines whether or not to authenticate the client. If the client is authenticated, the RADIUS server generates an Access-Accept RADIUS packet. If the client authentication is not successful, an Access-Reject RADIUS packet is generated. The packet that is generated is then sent to the proxy server.

Proxy Server Issues Policy Challenge

The proxy server receives Access-Accept packets from the RADIUS server and handles and alters them as described below. However, Access-Reject packets received from the RADIUS server are sent unaltered to the NAS. On receiving Access-Accept RADIUS packets from the RADIUS server, the Access-Accept RADIUS packet is altered by the proxy server forming a new Access-Challenge packet as illustrated in the following code from the “changeResponse” method of the ProxyServerjava class:

| | |
|---|---|
| 1: | //Portion of the changeResponse method defined in the |
| | ProxyServer.java |
| 2: | |
| 3: | //Check to see if it is an Access Accept packet and set the approp |
| 4: | else |
| 5: | { |
| 6: | if(packetType == PacketType.Access_Accept) |
| 7: | { |
| 8: | ai = prx.getRequestAttributeList( ); |
| 9: | |
| 10: | // Save the Identity from the EAP Packet |
| 11: | ExtendedEAPPacket ep = new ExtendedEAPPacket(ai); |
| 12: | //This normally should be the case.... where an Access Reject or an |
| 13: | //Access Accept packet contains an EAP success or a failure packet.. |
| 14: | //The radius server does not send an EAP packet. Therefore we don't |
| 15: | //expect it to arrive either. |
| 16: | |
| 17: | //Create a new EAP packet with an TYPE_30_MD5 Challenge |
| 18: | // Request |
| 19: | |
| 20: | ExtendedEAPPacket EAP = new |
| | ExtendedEAPPacket(TYPE_30_MD5); |
| 21: | |
| 22: | ai.mergeAttributes (EAP.createChallengeRequest(packetId, “ |
| | Send you |
| 23: | prx.appendResponseAttributes(ai); |
| 24: | prx.setResponseType(PacketType.Access_Challenge); |
| 25: | } |
| 26: | } |

As illustrated at line 6 above, a check is made to determine if the packet received from the RADIUS server is an Access-Accept packet. If the packet is an Access-Accept packet, the EAP success packet is replaced by a new EAP policy challenge packet requesting information regarding the policy present on the client system as shown at lines 20-24.

The NAS passes the EAP message generated by the proxy server to the client. The client processes the EAP packet and generates an EAP packet containing a response to the policy challenge. As described above, the client checks the EAP packet to determine the presence of an embedded basic type EAP packet. However, in this case, there is no embedded basic type EAP packet; instead, the extended EAP packet contains the policy challenge (this is a request for policy information regarding the client machine). The client responds by generating a login message containing the policy data and security state data retrieved from the security engine API (e.g., as raw bytes of EAP data) and forms an EAP packet containing this data. This EAP packet is then forwarded to the NAS.

Response to Policy Challenge Processed by Proxy Server

Upon receipt of the response from the client device, the NAS passes the extended EAP packet in an Access-Request packet to the proxy server. The proxy server processes the Access-Request packet and determines if it is to be forwarded to the primary RADIUS server or to the integrity gateway (IGW) server for authentication of the client. The following “authenticate” method illustrates the processing of this packet by the proxy server:

| | |
|---|---|
| 1: | REAPAccessImplFactory.java, Class REAPAccessImpl |
| 2: | |
| 3: | public void authenticate(AuthInfo authInfo) throws |
| | AccessRejectException, |
| 4: | { |
| 5: | // This method verifies the login message received in the EAP |
| | packet. |
| 6: | // Gathers the provider information and sends it to the IGW server |
| 7: | // which then sends this to the integrity server. It then returns an |
| 8: | // EAP accept/reject packet depending on the response of the |
| 9: | // Integrity Server |
| 10: | |
| 11: | EAPInfo EAPInfo = authInfo.getEAP( ); |
| 12: | |
| 13: | //Ignore non-EAP messages |
| 14: | if(EAPInfo == null) |
| 15: | return; |
| 16: | |
| 17: | // if a start packet arrives..simply return! |
| 18: | if(EAPInfo.handleStartPacket (null)) |
| 19: | return; |
| 20: | |
| 21: | EAPPacket ep = EAPInfo.getPacket( ); |
| 22: | |
| 23: | // This handling of the EAP Packet occurs when we have a sent a |
| 24: | // specific EAP30 challenge a response Identity packet is not expected |
| 25: | // .. if it arrives throw an AccessRejectException |
| 26: | |
| 27: | if(ep.isIdentity( ) && ep.getCode( ) != |
| | EAPPacket.CODE_RESPONSE) |
| 28: | { |
| 29: | throw new AccessRejectException(“ Unexpected EAP |
| | packet arrived” |
| 30: | } |
| 31: | |
| 32: | // else the packet that arrived is a code response packet..check if is |
| 33: | //of the right EAP type |
| 34: | if(ep.getType( ) == TYPE_30_MD5) |
| 35: | { |
| 36: | |
| 37: | try |
| 38: | { |
| 39: | // We have right kind of EAP packet... |
| 40: | |
| 41: | byte[] message = ep.getData( ); |
| 42: | |
| 43: | // Extract the login message from the packet |
| 44: | |
| 45: | AbstractMessage m = LoginMessage.getMessage(message); |
| 46: | |
| 47: | // Send the message to the validator object passed in as a parameter |
| 48: | |
| 49: | if(validator.validate(m)) // This means that an query accept was |
| 50: | //sent to us by the Integrity Server |
| 51: | { |
| 52: | AttributeList responseList = ep.createSuccessResponse(ep.ge |
| 53: | authInfo.setResponseAttributes(responseList); |
| 54: | authInfo.setAccessAccept( ); |
| 55: | } |
| 56: | |
| 57: | else |
| 58: | { |
| 59: | // Set the EAP failure response |
| 60: | |
| 61: | |
| 62: | AttributeList responseList = ep.createFailureResponse(e |
| 63: | authInfo.setResponseAttributes(responseList); |
| 64: | authInfo.setResponseType(PacketType.Access_Reject); |
| 65: | |
| 66: | //alternatively, set success response with a filter to restrict access |
| 67: | } |
| 68: | |
| 69: | } |
| 70: | catch(Exception e) |
| 71: | { |
| 72: | e.printStackTrace( ); |
| 73: | throw new AccessRejectException(“Incorrect Policy |
| | Type”); |
| 74: | } |
| 75: | } |
| 76: | // We don't know the EAP type.. |
| 77: | else |
| 78: | { |
| 79: | throw new AccessRejectException(“Unknown EAP type”); |
| 80: | } |
| 81: | } // End method |

On receiving the Access-Request packet, as in the previously described cases, the proxy server parses this extended EAP packet to determine whether it contains a response to the policy challenge as shown at lines 27-34. If the proxy server concludes that the EAP packet contains data required for policy-based authentication, it then extracts the EAP packet and constructs a login message from the data contained within the EAP packet as shown at lines 41-45. This login message contains the policy information (e.g., in MD5 format) regarding the client and other relevant information required to determine the client's compliance status. The login message is then sent to the IGW server for authentication by the policy server as shown at line 49 (i.e., the below “validate” method of the IGW server is called).

As provided at line 49 above, if the “validate” method returns true (indicating that the policy server successfully validated the client), a success response is created as shown at lines 51-55 above. However, if the client is not validated (i.e., the “validate” method returns false), a failure response is set as shown at lines 58-76. The “validate” method of the IGW server will now be described.

Client Policy Data Sent to Policy Server for Validation

The integrity gateway (IGW) server asks the policy evaluation engine (i.e., the policy server) to approve the information supplied by the client in the extended EAP packet. This is done by sending a login message (IaLogin) to the policy server as illustrated in the following “validate” method of the IGWServerjava class:

| | |
|---|---|
| 1: | IGWServer.java |
| 2: | |
| 3: | public boolean validate( AbstractMessage m) |
| 4: | { |
| 5: | |
| 6: | // Hard coding this to be of type IALogin |
| 7: | |
| 8: | IaLoginMessage ia = (IaLoginMessage)m; |
| 9: | |
| 10: | |
| 11: | if (sessions.containsKey(ia.getSessionId( ))) |
| 12: | { |
| 13: | |
| 14: | //Get the object from the Hash Map |
| 15: | Session session = (Session) sessions.get(ia.getSessionId( )); |
| 16: | |
| 17: | System.out.println(“Sending the query to the GREAT |
| | Integrity Se |
| 18: | |
| 19: | // Send IGWQuery message |
| 20: | sendQuery(ia); |
| 21: | |
| 22: | // Block until response |
| 23: | try |
| 24: | { |
| 25: | synchronized(session) |
| 26: | { |
| 27: | while (session.getResponse( ) == null) |
| 28: | { |
| 29: | session.wait( ); |
| 30: | } |
| 31: | } |
| 32: | |
| 33: | Message reply = (Message)session.getResponse( ); |
| 34: | if (reply.getType( ) == |
| | Message.ISS_IGW_QUERY_ACCEPT) |
| 35: | { |
| 36: | endSession(session); |
| 37: | System.out.println(“QUERY ACCEPTED”); |
| 38: | return true; |
| 39: | |
| 40: | } |
| 41: | else |
| 42: | { |
| 43: | endSession(session); |
| 44: | System.out.println(“QUERY REJECTED”); |
| 45: | return false; |
| 46: | } |
| 47: | } // end try |
| 48: | |
| 49: | catch (InterruptedException e) |
| 50: | { |
| 51: | e.printStackTrace( ); |
| 52: | } |
| 53: | } // end if |
| 54: | // This is only if the IGWServer does not know about this |
| | session at |
| 55: | return false; |
| 56: | } |

As shown at line 8 above, a login message is formed for transmission to the policy server. The login message is in format understood by the policy server and includes information about the policy compliance and configuration of the client. As shown at line 20 above, the login message is sent as an “IGW_QUERY” message to the policy server. The IGW server then waits for a response to the message from the policy server as illustrated at lines 27-30 above.

When a reply message is received from the policy server (policy engine), the reply is parsed and processed by the message processor of the IGW server as shown at lines 33-46. The reply message sent by the policy server is either an “IGW_QUERY_ACCEPT” or an “IGW_QUERY_REJECT” message. If the response is an “IGW_QUERY_ACCEPT” message as shown at line 34, then the policy evaluation by the policy server indicates that the RADIUS authentication should succeed. In this event, this “validate” method returns true as shown at line 38. As described above, this causes the above “authenticate” method of the IGW server to indicate the client was successfully authenticated by the policy server. This results in the issuance of a RADIUS Access-Accept message to the NAS. However, if the response is not an “IGW_QUERY_ACCEPT” message, then the “else” condition at line 41 applies and the policy evaluator indicates that the RADIUS authentication should not succeed. In this event the query is rejected and a RADIUS Access-Reject message is sent to the NAS. Alternatively, a RADIUS Access-Accept message can be sent to the NAS, with a filter attribute indicating network access is to be restricted.

Alternative Embodiments

As an alternative embodiment, a RADIUS server may be employed that is able to wrap and unwrap packets and provide for routing them to the appropriate destination. In this case, the RADIUS server can take on several (or all) of the tasks of the proxy server in the above-described embodiment and illustrated at FIG. 5. In this alternative embodiment, instead of the proxy server receiving communications between the client (or NAS) and the RADIUS server, the RADIUS server handles these communications by itself and invokes another RADIUS server that is similar to the proxy server of the presently preferred embodiment, but which is not acting in proxy mode. This other RADIUS server, in turn, invokes the IGW server and the policy server for policy negotiation and enforcement. The first RADIUS server communicates directly with the NAS and handles normal authentication services while also invoking the other server-side components for implementing the methodology of the present invention for policy enforcement. This alternative embodiment may be desirable so that the NAS may communicate directly with the first RADIUS server for security or performance reasons.

In another alternative embodiment, an IAS server (a Microsoft server providing RADIUS authentication services) may be used without the need for a separate proxy server. In this embodiment, the IAS server (available from Microsoft Corporation of Redmond, Wash.) also communicates directly with the NAS and passes requests down to an implementation dynamic link library (DLL) for invoking the policy server in order to implement the policy enforcement methodology of the present invention.

In another alternative embodiment, a RADIUS server and EAP authentication can be used to authenticate access to host devices that are not network access servers. For example, a RADIUS server and EAP authentication can be used to authenticate client devices for access to a web server. Although these other host devices (e.g., web servers) may have other available authentication systems, a RADIUS server and EAP can be used to authenticate access to these servers and may employ the system and methodology of the present invention for providing policy enforcement for these environments. The methodology of the present invention does not require a network access server, but instead may be used for connecting a device (or a server) to a secured host (or to a service on the host). Similarly, the methodology of the present invention does not require the RADIUS or EAP protocols but may be used with any extensible authentication protocol, including for example the Generic Security Service API (GSS-API) as well as RADIUS/EAP.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention. For example, although the currently preferred embodiment of the present invention operates in conjunction with a network access server environment which includes a RADIUS server and uses the Extensible Authentication Protocol (EAP), the methodology of the present invention may also be used for connecting to a secured host (or to a service on the host) using any extensible authentication protocol, including for example the GSS-API (Generic Security Service API) as well as RADIUS/EAP. In addition, although the above description includes a client device accessing a network access server to gain access to a network, client devices which may connect to a network access server or a secured host may include another network access server which connects for the purpose of securely linking together two networks.

1. A system for authentication of a client device for access to a network, the system comprising:
a first authentication module that establishes a session with a client device requesting network access, said session for collecting information from the client device and determining whether to authenticate the client device for access to the network based, at least in part, upon the collected information; and
a second authentication module that participates in said session with the client device for supplemental authentication of the client device for access to the network, said supplemental authentication based, at least in part, upon the collected information and a policy required as a condition for network access.

2. The system of claim 1, wherein said policy required as a condition for network access comprises a security policy.

3. The system of claim 1, wherein said policy required as a condition for network access includes anti-virus measures required on the client device.

4. The system of claim 1, wherein said policy required as a condition for network access includes security measures required on the client device.

5. The system of claim 1, wherein participation by the second authentication module in said session with the client device includes trapping communications between the first authentication module and the client device.

6. The system of claim 1, wherein said first authentication module exchanges communications with the client device using an authentication protocol.

7. The system of claim 6, wherein said authentication protocol comprises an Extensible Authentication Protocol (EAP).

8. The system of claim 6, wherein said authentication protocol comprises a Generic Security Services Application Program Interface (GSS-API) based protocol.

9. The system of claim 6, wherein the information collected from the client device is packaged within Extensible Authentication Protocol (EAP) communications.

10. The system of claim 1, further comprising:
a client authentication module on the client device for gathering information required for supplemental authentication of the client device.

11. The system of claim 10, wherein said client authentication module gathers information about policy enforcement on the client device.

12. The system of claim 10, wherein said client authentication module packages the collected information into Extensible Authentication Protocol (EAP) packets for transmission.

13. The system of claim 1, wherein the client device comprises a server which requests network access for the purpose of linking together at least two networks.

14. The system of claim 1, wherein said first authentication module includes a Remote Authentication Dial In User Service (RADIUS) server.

15. The system of claim 1, wherein said first authentication module includes an Internet Authentication Service (IAS) server.

16. The system of claim 1, wherein said second authentication module includes a policy server.

17. A method for enforcing compliance with security rules required as a condition for access, the method comprising:
specifying security rules required as a condition for access;
detecting a request for access from a client;
verifying authentication of the client requesting access, including collecting information from the client;
if the client is authenticated for access, providing access to the client in accordance with the security rules based at least in part on said information collected during authentication.

18. The method of claim 17, wherein said detecting step includes detecting a request for access to a network.

19. The method of claim 17, wherein said detecting step includes detecting a request for access to a host.

20. The method of claim 19, wherein said host includes a web server.

21. The method of claim 17, wherein said client includes a network access server connecting to link together at least two networks.

22. The method of claim 17, wherein said verifying authentication step includes using an authentication protocol.

23. The method of claim 22, wherein said authentication protocol comprises a Generic Security Services Application Program Interface (GSS-API) based protocol.

24. The method of claim 22, wherein said authentication protocol comprises an Extensible Authentication Protocol (EAP).

25. The method of claim 24, wherein said information collected from the client is packaged within EAP packets.

26. The method of claim 24, wherein said information collected from the client is included as extended attributes of EAP packets sent by the client.

27. The method of claim 17, wherein said verifying authentication step includes using a client-side component for gathering information regarding the client.

28. The method of claim 27, wherein said client-side component packages the gathered information in Extensible Authentication Protocol (EAP) packets.

29. The method of claim 17, wherein said providing access step includes blocking access if the client is determined not to be in compliance with the security rules.

30. The method of claim 17, wherein said providing access step includes applying a restrictive filter if the client is determined not to be in compliance with the security rules.

31. The method of claim 17, wherein said providing access step includes allowing access subject to conditions if the client is determined not to be in compliance with the security rules.

32. The method of claim 17, wherein said providing access step includes redirecting a client determined not to be in compliance to a sandbox server for remedying compliance.

33. A computer-readable medium having computer-executable instructions for performing the method of claim 17.

34. A downloadable set of computer-executable instructions for performing the method of claim 17.

35. A method for enforcing compliance with a security policy required as a condition for access to at least one resource, the method comprising:
specifying a security policy required for access to at least one resource;
detecting a request for access from a particular computer;
attempting authentication of said particular computer, including determining the particular computer's compliance with the security policy;
if the particular computer is authenticated and is in compliance with the security policy, providing access in accordance with the security policy; and
otherwise, denying access.

36. The method of claim 35, wherein said detecting step includes detecting a request for access to a network.

37. The method of claim 35, wherein said particular computer includes a network access server connecting to link together at least two networks.

38. The method of claim 35, wherein said attempting authentication step includes using an authentication protocol that is extensible.

39. The method of claim 35, wherein the security policy comprises a plurality of rules.

40. The method of claim 39, wherein providing access includes allowing access to a resource permitted under said rules.

41. The method of claim 39, wherein access to a resource is denied if not permitted under said rules.

42. The method of claim 35, wherein said attempting authentication step includes using a component on said particular computer for determining compliance with the security policy.

43. The system of claim 35, wherein said denying step includes restricting said particular computer to an area of the network for remedying compliance.

44. An improved method for authenticating a device for access to a network including an improvement for determining compliance with a policy required as a condition for access, the improvement comprising:
specifying a policy required as a condition for network access;
determining whether the device is in compliance with the policy during attempted authentication of the device; and
if the device is authenticated, allowing network access based upon the determination made about the device's compliance with the policy.

45. The improvement of claim 44, wherein said determining step includes using an authentication protocol for providing information about compliance with the policy.

46. The improvement of claim 45, wherein said authentication protocol comprises a Generic Security Services Application Program Interface (GSS-API) based protocol.

47. The improvement of claim 45, wherein said authentication protocol comprises an Extensible Authentication Protocol (EAP).

48. The improvement of claim 47, wherein said Extensible Authentication Protocol is extended to provide for policy negotiation.

49. The improvement of claim 44, further comprising:
providing a component on the device for generating information about policy compliance.

50. The improvement of claim 49, wherein said component packages the information in Extensible Authentication Protocol (EAP) packets.

51. The improvement of claim 44, wherein said allowing step includes allowing partial access.

52. The improvement of claim 44, wherein said allowing step includes allowing access subject to conditions if the device is not in compliance with the policy.

53. A system for determining an access policy to be applied to a device requesting access to a network, the system comprising:
a network access module for receiving a request for network access from a device and regulating access to the network;
a primary authentication module which communicates with the device for determining whether the device is authorized to access the network; and
a secondary authentication module which participates in communications between the device and the primary authentication module for determining an access policy to be applied to the device based upon a security policy required as a condition of network access.

54. The system of claim 53, wherein said network access module applies the access policy determined by the secondary authentication module.

55. The system of claim 53, wherein said primary authentication module exchanges communications with the device using an authentication protocol.

56. The system of claim 55, wherein said authentication protocol comprises an Extensible Authentication Protocol (EAP).

57. The system of claim 56, wherein Extensible Authentication Protocol communications between the device and the primary authentication module are extended to include security attributes of the device.

58. The system of claim 53, wherein said access policy specifies network resources that may be accessed by the device based upon compliance with the security policy.

59. The system of claim 53, wherein said access policy includes allowing partial access to the network.
